(19) United States
(12) Patent Application Publication
(10) Pub. No.: US 2005/0041521 A1
(43) Pub. Date: Feb. 24, 2005

(54) Screw-type extruding machine comprising mixing and kneading disks

(76) Inventor: Rainer Herter, Untergruppenbach (DE)

Correspondence Address: MCGLEW & TUTTLE, PC, 1 SCARBOROUGH STATION PLAZA, SCARBOROUGH, NY, 10510-0827, US

(21) Appl. No.: 10/921,658

(22) Filed: Aug. 19, 2004

(30) Foreign Application Priority Data
Aug. 22, 2003 (EP) 03 019 034.2

(51) Int. Cl. B29B 7/48

(52) U.S. Cl. 366/82; 366/85

(57) ABSTRACT

A screw-type extruding machine comprises at least two casing bores with screw shafts disposed therein, on which several successive mixing and kneading disks are mounted, interengaging in pairs. Successive mixing and kneading disks make an angle of crest misalignment which is not integrally contained in 360°.

### BACKGROUND OF THE INVENTION

1. Field of the Invention

The invention relates to a screw-type extruding machine comprising at least two parallel, intersecting casing bores; rotarily drivable screw shafts which are disposed in the casing bores; and several mixing and kneading disks which are successively disposed on the screw shafts and interengage in pairs, having at least one crest and at least one flank.

2. Background Art

Screw-type extruding machines of the generic type which comprise mixing and kneading disks of the generic type have been known to a wide extent, for example from U.S. Pat. No. 6,048,088, U.S. Pat. No. 4,824,256 and EP 1 121 238 B1. In these known screw-type extruding machines, several mixing and kneading disks are successively disposed on a screw shaft, combining to constitute a kneading block. These kneading blocks are designed such that the angle of crest misalignment made by neighboring kneading disks is integrally contained in 360°. The first and last mixing and kneading disk of a kneading block frequently are congruent. Kneading blocks with five successive mixing and kneading disks and two-flight design may for example comprise successive mixing and kneading disks of an angle of crest misalignment of 45°.

With the positions of engagement of the mixing and kneading disks of a pair of mixing and kneading disks varying upon rotation of the screw shaft and thus of the mixing and kneading disks, varying turning moments will result during a motion of rotation and act on the respective screw shaft. In the above, known design and arrangement of mixing and kneading disks, torque momenta—short, strong turning moment increases—result, which are still increased by the fact that congruent positions of the mixing and kneading disks occur simultaneously for several times in the described symmetric kneading blocks. As a result, considerable vibratory stresses can occur in the entire drive train in the case of resonance. The drive train comprises all rotary pats of the driving motor, coupling and transmission, and the screw shafts with mixing and kneading disks and, possibly, screws.

### SUMMARY OF THE INVENTION

It is an object of the invention to improve the screw-type extruding machine in such a way that vibratory problems are at least reduced.

According to the invention, this object is attained by features in which directly successive mixing and kneading disks make an angle of crest misalignment, it applying that an integral multiple of the respective angle of crest misalignment is unequal to 360°.

As a result of the design according to the invention, not even a great number of mixing and kneading disks in successive arrangement will be able to occasion simultaneous torque momenta that might lead to inadmissibly high amplitudes in the vicinity of resonance spots of the drive train.

With none of the successive mixing and kneading disks being congruent, this is an even better way of obtaining the effect envisaged by the invention.

Further features, details and advantages of the invention will become apparent from the ensuing description of an exemplary embodiment, taken in conjunction with the drawing.

### BRIEF DESCRIPTION OF THE DRAWING

FIG. 1 is a diagrammatic plan view of a screw-type extruding machine in an illustration sectionally broken away;

FIG. 2 is a lateral view of a kneading block comprising five mixing and kneading disks;

FIG. 3 is an elevation of the kneading block in accordance with the arrow III of FIG. 2;

FIG. 4 is another elevation of the kneading block in accordance with the arrow IV of FIG. 2; and

FIG. 5 is a cross-sectional view of the screw-type extruding machine on the line V-V of FIG. 1.

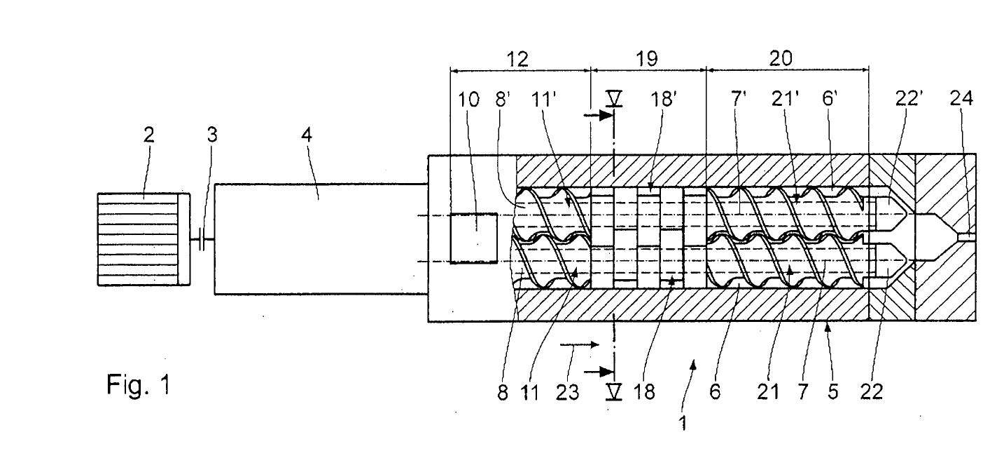

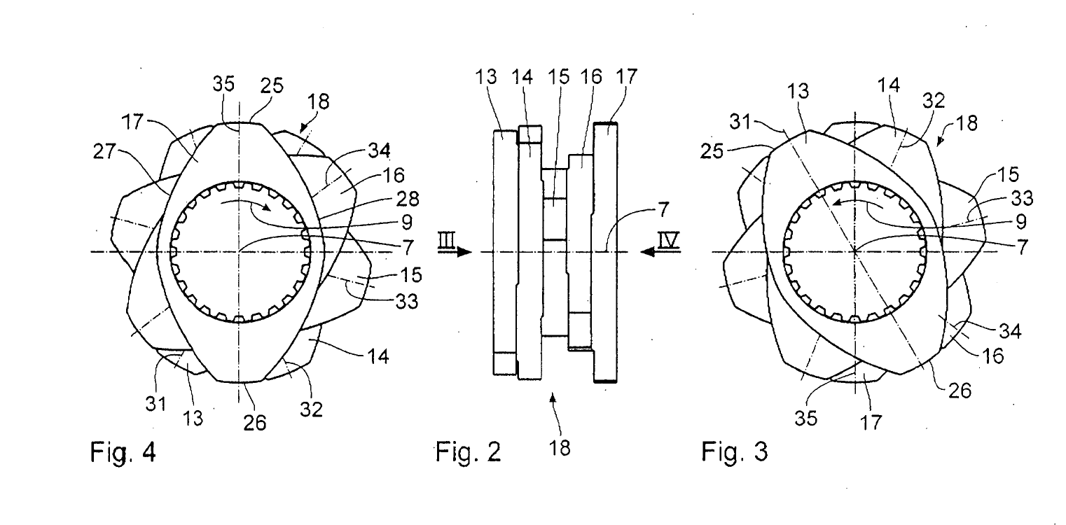

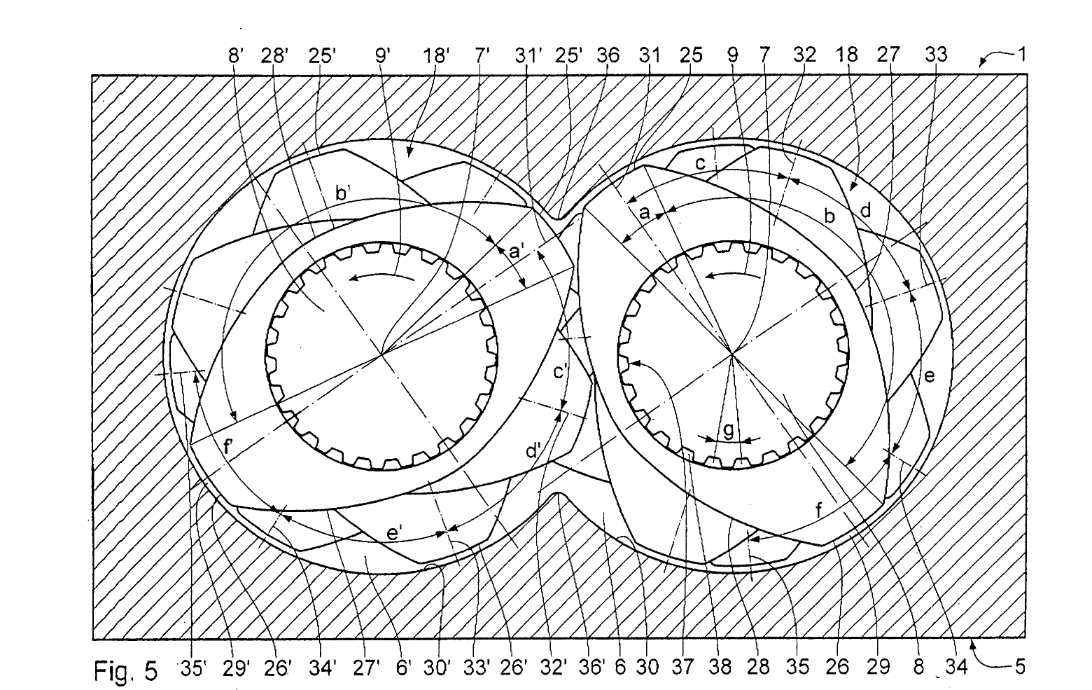

### DESCRIPTION OF A PREFERRED EMBODIMENT

The twin-screw extruder 1 seen in the drawing is driven by a motor 2 via a coupling 3 and a subsequent transmission 4. The casing 5 of the screw-type extruding machine 1 includes two casing bores 6, 6′ which intersect in the form of a horizontal figure eight, having parallel axes 7, 7′. Screw shafts 8, 8′ are disposed in the bores 6, 6′, the axes of which coincide with the axes 7, 7′. The screw shafts 8, 8′ are driven by way of the transmission 4 in the same direction of rotation 9, 9′.

At its end in vicinity to the transmission 4, the casing 5 comprises a feed hopper 10, through which to supply material that is to be treated. Subsequently, screws 11, 11′ are mounted on the screw shafts 8, 8′, constituting a feed zone 12.

Subsequently, mixing and kneading disks 13, 13′, 14, 14′, 15, 15′, 16, 16′ and 17, 17′ are non-rotatably mounted on the screw shafts 8, 8′; they are integrally embodied as kneading blocks 18, 18′ in the exemplary embodiment shown. A mixing and kneading zone 19 is formed in the vicinity of these kneading blocks 18, 18′, which is followed by a conveying and pressure build-up zone 20 again including screws 21, 21′ that are non-rotatably mounted on the screw shafts 8, 8′. After these screws 21, 21′, screw tips 22, 22′ are formed on the screw shafts 8, 8′, which, in the conveying direction 23 i.e., at the end opposite the feed hopper 10, are followed by a die 24 that finishes the casing 5. The screws 11, 11′ which are arranged in pairs as well as the mixing and kneading disks 13, 13′ to 17, 17′ and the screws 21, 21′ are embodied for interengagement i.e., they mesh closely. The rotary parts of the motor 2, coupling 3 and transmission 4 and the screw shafts 8, 8′, along with the screws 11, 11′ as well as the mixing and kneading disks 13, 13′ to 17, 17′, constitute a drive train.

As seen in the drawing, the screws 11, 11′ and 21, 21′ as well as the mixing and kneading disks 13, 13′ to 17, 17′ are two-flight. The disks 13, 13′ to 17, 17′ consequently have crests 25, 25′ and 26, 26′ and flanks 27, 27′ and 28, 28′ which, upon rotation in the direction of rotation 9, 9′, move past each other in a manner known per se. The crests 25, 25′ and 26, 26′ rotate by some play i.e., leaving a minor gap 29, 29′, towards the wall 30, 30′ of the casing bore 6, 6′. A crest 25, 26 of a mixing and kneading disk 13 to 17 runs by some minor clearance past a flank 27′, 28′ of another mixing and kneading disk 13′ to 17′ allocated to the pair, and vice versa. This is general practice taught for two-flight mixing and kneading disks by U.S. Pat. No. 6,048,088, or for one-flight mixing and kneading disks by EP 1 121 238 B1, or for three- or four-flight mixing and kneading disks by U.S. Pat. No. 4,824,256.

The successive disks 13, 13′ to 17, 17′ are cross-sectionally identical crosswise of the axis 7 and 7′. Each individual disk, when of two-flight design, is doubly mirror symmetric. The disks have a crest angle a or a′ and a flank angle b or b′, with a+b=a′+b′=180° and a=a′ and b=b′ applying in the case of two-flight design. Center planes 31, 31′, 32, 32′, 33, 33′, 34, 34′ and 35, 35′ centrally intersect the crests 25, 26 and 25′, 26′ and the respective axis 7, 7′, with the two center planes of mixing and kneading disks that are directly successive in the conveying direction 23 making an angle of crest misalignment. Consequently, the center planes 31, 32 of the disks 13, 14 make an angle c, whereas the center planes 31′, 32′ of the disks 13′, 14′ make an angle c′. The center planes 32, 33 of the disks 14, 15 make an angle d, whereas the center planes 32′, 33′ of the disks 14′, 15′ make and angle d′. The center planes 33, 34 of the disks 15, 16 make an angle e, whereas the center planes 33′, 34′ of the disks 15′, 16′ make an angle e′. Finally, the center planes 34, 35 of the disks 16, 17 make an angle f, whereas the center planes 34′, 35′ of the disks 16′, 17′ make an angle f. The angles of crest misalignment of each pair of mixing and kneading disks 13 and 13′ or 14 and 14′, and so forth, are identical, with c=c′, d=d′, e=e′ and f=f applying. On the other hand, c, d, e, f and c′, d′, e′, f need not be respectively identical. Rather, an integral multiple of the respective angles of crest misalignment c, c′, d, d′, e, e′, f, f′ must be unequal to 360°. In other words, the angle of crest misalignment between two mixing and kneading disks that adjoin in the conveying direction 23 is not contained integrally in 360°. As a result, even with several successive pairs of mixing and kneading disk 13, 13′ to 17, 17′, there will be no identical position of engagement of two pairs of mixing and kneading disks.

By way of explanation it is added that the turning moments exercised by a respective pair of mixing and kneading disks 13, 13′ to 17, 17′ on the screw shaft 8, 8′ are not constant during an entire rotation. As a result, in particular when several pairs of mixing and kneading disks are arranged successively, any material to be treated, namely melt, powder etc., can only escape in the conveying direction 23. With the free cross sections varying during complete rotation of the disks of a pair of disks, varying turning moments occur during a rotation of each screw shaft 8 and 8′. The highest turning moments occur when two crests 25, 25′ and 26, 26′ are in the vicinity of a respective approximate triangle 36 and 36′. These approximate triangles 36, 36′ are the acute areas that form in the casing 5 where the casing bores 6, 6′ pass into each other. In this position, the free cross section of the casing bores 6, 6′ is especially small. With the angles of crest misalignment between the mixing and kneading disks, according to general practice, integrally going into 360° and, in the case of two-flight mixing and kneading disks, integrally going into 180°, in particular when amounting to 45° for two-flight disks, then, during a rotation of the screw shafts 8, 8′, these fluctuations of torque, during a respective rotation of the screw shafts 8, 8′, occur at a frequency that depends on the speed of the screw shafts 8, 8′. With a resonant frequency of the drive train corresponding to the mentioned frequency of the turning-moment fluctuations, these turning-moment amplitudes would be inadmissibly increased at the spots of resonance, given a conventional arrangement of the mixing and kneading disks with angles of crest misalignment contained integrally in 360°. The specified measures largely preclude this problem.

As seen in FIG. 5, the screw shafts 8, 8′ have an external serration which engages with an internal serration 37 of the mixing and kneading disks 13, 13′ to 17, 17′, this producing a non-rotary connection between the disks and the screw shafts 8, 8′. The same applies to the screws 11, 11′ and 21, 21′. The serration 37 has a pitch angle g which goes integrally into 360°. g=15° applies when twenty-four teeth 38 are disposed along the periphery; g=10° applies in the case of thirty-six teeth 38; g=30′ applies when twelve teeth 38 are disposed along the periphery; and so forth. With several disks 13, 13′ to 17, 17′ disposed successively, the sum of the angles of crest misalignment c+d+e+f is advantageously equal to an integral multiple of g. In this case, further similar leading blocks or screws can be joined without any misalignment or additional special transition elements.

1. A screw-type extruding machine, comprising
at least two parallel, intersecting casing bores (6, 6′);
rotarily drivable screw shafts (8, 8′) which are disposed in the casing bores (6, 6′); and
several mixing and kneading disks (13, 13′ to 17, 17′) which are successively disposed on the screw shafts (8, 8′) and interengage in pairs, having
at least one crest (25, 25′, 26, 26′) and
at least one flank (27, 27′, 28, 28′);
wherein directly successive mixing and kneading disks (13 to 17 and 13′ to 17′) make an angle of crest misalignment (c, d, e, f, c′, d′, e′, f′), it applying that an integral multiple of the respective angle of crest misalignment (c, d, e, f; c′, d′, e′, f′) is unequal to 360°.

2. A screw-type extruding machine according to claim 1, wherein none of the successive mixing and kneading disks (13 to 17 and 13′ to 17′) are congruent.

3. A screw-type extruding machine according to claim 1, wherein the mixing and kneading disks are n-flight, with n=1, 2, 3 or 4 applying.

4. A screw-type extruding machine according to claim 3, wherein the mixing and kneading disks (13, 13′ to 17, 17′) are two-flight.

5. A screw-type extruding machine according to claim 1, wherein the screw shafts (8, 8′) are drivable in the same direction.

6. A screw-type extruding machine according to claim 1, wherein several mixing and kneading disks (13 to 17 and 13′ to 17′) constitute a kneading block (17 and 18′).

7. A screw-type extruding machine according to claim 6, wherein the kneading blocks (18, 18′) are connectable to the screw shafts (8, 8′) by a serration (37), the serrations (37) having teeth (38) that are disposed at equal angular distances, adjoining teeth (27) making a pitch angle (g); and wherein the sum of the angles of crest misalignment (c+d+e+f and c′+d′+e′+f′) of several mixing and kneading disks (13 to 17 and 13′ to 17′) of a kneading block (18 and 18′) being an integral multiple of the pitch angle (g).
